(19) United States
(12) Patent Application Publication
(10) Pub. No.: US 2022/0214689 A1
(43) Pub. Date: Jul. 7, 2022

(54) Autonomous Vessel and Infrastructure for Supporting an Autonomous Vessel on Inland Waterways

(71) Applicant: Flumensys Technologies B.V., Delft (NL)

(72) Inventor: Juraj Pavlica, Delft (NL)

(21) Appl. No.: 17/565,292

(22) Filed: Dec. 29, 2021

Related U.S. Application Data
(60) Provisional application No. 63/133,672, filed on Jan. 4, 2021.

(51) Int. Cl. G05D 1/02; B63B 79/40; B63B 79/15; G05D 1/00

(52) U.S. Cl. CPC G05D 1/0206; G05D 1/0088; B63B 79/15; B63B 79/40

(57) ABSTRACT

A method of controlling a vessel along an inland waterway is presented that includes receiving sensor data including geographic location data from a plurality of sensors on the vessel; providing sensor data to edge nodes, the one or more edge nodes associated with the geographic location of the vessel; receiving tiled data from the one or more edge nodes; determining operating parameters to perform a mission task based on tiled data from the one or more edge nodes and the sensor data, the tiled data associated with the geographical position of the vessel, the tiled data including data associated with feature objects within the geographic area associated with the tiled data; determining control signals from the operating parameters; and providing control signals to a vessel control array to control vessel heading and speed according to the control signals.

### RELATED APPLICATIONS

The present application claims priority to U.S. Application Ser. No. 63/133,672, entitled “Autonomous Vessel and Infrastructure for Supporting an Autonomous Vessel on Inland Waterways,” filed on Jan. 4, 2021, which is herein incorporated by reference in its entirety.

### TECHNICAL FIELD

Embodiments of the present invention are related to Autonomous Vessels and, in particular, to Autonomous Vessels for inland waterway applications.

### DISCUSSION OF RELATED ART

Autonomous vehicles, and in particular, autonomous vessels are currently being developed for multiple applications. In general, an autonomous vessel refers to a vessel that includes one or more autonomous systems capable of making decisions and performing actions with or without human participation. An autonomous vessel may be crewless or nearly crewless vessels. Autonomous vessels can transport passengers and/or cargo, generally through open water, between ports, inside ports, and within navigable waterways. Levels of automation can be classified from no automation (fully crewed) to fully automated (no human intervention). Many vessels under operation today have some level of automation, but generally still require a crew for operation. These vessels are generally being developed for cargo carrying vessels in open ocean operation. However, operation of autonomous vessels in inland waterways and within ports has not previously been addressed.

The compilation of high definition maps from sensors carried on vessels traveling along a route covered by the map is taught in U.S. Publ. 2018/0188039, for example. Additionally, use of edge resources for providing computational resources to control automated vessels has also been described, for example, in CN108845885A. However, the data structures used, and the computational resources provided are not sufficient to control autonomous vessels.

Therefore, there is a need to develop autonomous systems for vessels operating on inland waters.

### SUMMARY

In some embodiments, a method of controlling a vessel is presented. The method can include receiving sensor data from a plurality of sensor systems that are distributed on the vessel, the plurality of sensors collecting sensor data related to objects adjacent the vessel, at least one of the plurality of sensor systems determining a geographic location of the vessel; providing sensor data to one or more edge nodes in communication with the vessel, the one or more edge nodes associated with the geographic location of the vessel; receiving tiled data from the one or more edge nodes; determining operating parameters to perform a mission task based on tiled data from the one or more edge nodes and the sensor data, the tiled data associated with the geographical position of the vessel, the tiled data including data associated with feature objects within the geographic area associated with the tiled data; determining control signals from the operating parameters; and providing control signals to a vessel control array, the vessel control array configured to control vessel heading and speed according to the control signals.

A control system on a vessel according to some embodiments includes a plurality of sensor systems distributed on the vessel, the plurality of sensors collecting sensor data related to objects adjacent the vessel, at least one of the plurality of sensor systems determining a geographic location of the vessel; a communications system configured to communicate with one or more edge nodes, the one or more edge nodes associated with the geographic location of the vessel; a vessel control array, the vessel control array configured to control vessel heading and speed according to control signals; an on-board processing unit, the on-board processing unit coupled to the plurality of sensors, the communications system, and the vessel control array. The on-board processing unit executes instructions to receive sensor data from the plurality of sensor systems; provide the sensor data to the one or more edge nodes; receive tiled data from one or more edge nodes; determine operating parameters to perform a mission task based on tiled data from the one or more edge nodes and the sensor data, the tiled data associated with a current geographical location of the vessel, the tiled data including data associated with feature objects within the geographic area associated with the tiled data, provide control signals based on the operating parameters to the vessel control array; and provide data from the plurality of sensor systems to the one or more edge nodes.

In some embodiments, a method of operating an edge node includes receiving sensor data from one or more autonomous vessels; determining a geographic position of a target vessel of the one or more autonomous vessels; associating a tile data with the geographic position, the tile data providing data associated with feature objects within a tiled region associated with the tile data, and providing data results to the target vessel that is associated with performance of a mission of the target vessel.

An edge node according to some embodiments includes a memory; a communications unit, the communications unit configured to communicate with a at least one other edge node, a cloud unit, and one or more autonomous vessels; and a processing unit coupled to the memory and the communications unit. The processing unit can execute instructions stored in the memory to receive sensor data from the one or more autonomous vessels, determine a geographic position of a target vessel of the one or more autonomous vessels, associate a tile data with the geographic position, the tile data stored in the memory and providing data associated with feature objects within a tiled region associated with the tile data, and provide data results to the target vessel that is associated with performance of a mission of the target vessel.

These and other embodiments are discussed below with respect to the following figures.

### BRIEF DESCRIPTION OF THE FIGURES

FIG. 1A illustrates an environment in which an autonomous vessel operates according to some embodiments of the present disclosure.

FIGS. 1B, 1C, 1D, and 1E illustrate aspects of an autonomous vessel according to some embodiments of the present disclosure.

FIG. 2 illustrates sensor deployment on an autonomous vessel according to some embodiments of the present disclosure.

FIG. 3 illustrates an edge node according to some embodiments of the present disclosure.

FIG. 4 illustrates a cloud unit according to some embodiments of the present disclosure.

FIG. 5 illustrates a data base structure used in the autonomous vessel, edge node, and cloud unit according to some embodiments of the present disclosure.

FIG. 6 illustrates a tile structure and edge node deployment according to some embodiments of the present disclosure.

FIG. 7 illustrates transition of autonomous vessel between edge nodes according to some embodiments.

FIGS. 8A and 8B illustrates example algorithms for operating an autonomous vessel according to some embodiments.

FIGS. 9A and 9B illustrate example algorithms for operating an edge node according to some embodiments.

FIG. 10 illustrates an example algorithm for operating a cloud processor according to some embodiments.

These and other aspects of embodiments of the present invention are further discussed below.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description illustrates inventive aspects and embodiments should not be taken as limiting—the claims define the protected invention. Various changes may be made without departing from the scope of this description and the claims. In some instances, well-known structures and techniques have not been shown or described in detail in order not to obscure embodiments of the invention.

A system for operating an automated vessel according to certain embodiments of the present disclosure includes a distributed computing system. The distributed computing system can include one or more edge nodes arranged along a path of the autonomous vessel that are communication with a control system on the automated vessel. According to some embodiments, mapping data can be distributed between the one or more edge nodes and used to control the autonomous vessel as it is operated to perform a mission task. The mission task in this circumstance is typically to transport the autonomous vessel from a first destination to a final destination along a waterway covered by the one or more edge nodes. A complete set of mapping data can be stored in a cloud processing unit that is coupled to communicate with each of the edge nodes.

The automated vessel can be equipped with a suite of sensors. Consequently, the edge nodes can receive sensor and image data captured by a plurality of sensors mounted on the automated vessel. In some embodiments, the edge nodes and the automated vessel can further receive sensor data from sensors that are installed on fixed maritime infrastructure adjacent to the waterway that can capture data from various sources, including various sensor systems, point cloud data, and image data information about waterways or related infrastructure. The edge nodes can use this sensor data to update the mapping data that is stored within each edge node and can further update that mapping data for that geographic location that is stored in the cloud processing unit.

The mapping data is stored as layered tiled data. The tiled data is associated with a geographic boundary. Each tile represents a member of a two-dimensional grid of tiles that divides a large physical geographical region into smaller geographical areas. The tile data stores data relevant for the particular geographical area identified by the tile. Each tile data can use an object or a data record that identifies various attributes. These attributes can include, for example, a unique identifier for the geographical region of the tile, a unique name for the geographical region of the tile, description of the boundary of the geographical region of the tile, and a collection of landmark features and occupancy grid data (e.g. objects) that are within the geographic region of the tile. Landmark features can, for example, include various points of interest such as quay side, charging or fueling stations, mooring sites, wharfs, and other features. Boundaries can, for example, be identified with latitude and longitude coordinates.

The tiles are arranged to span the entire geographical region that is traversed by the autonomous vessel to perform its mission task. Each tile can be a particular geometric shape, for example a polygon, and the tiles together contiguously span the entire geographic region. The tiles may be of different sizes, depending on factors such as topographic and bathymetric features, safety or security requirements, wireless communication constraints, available data storage requirements, or predefined constraints with respect to dimensions.

Each tile data can include data within a buffer of a predetermined width around the corresponding tile and wherein said buffer comprises redundant map data around all sides/boundaries of a geographic region. In some embodiments, the system switches the current tile data relevant to the tile associated with the current geographical region of the vessel from a first tile data to the second tile data of the neighboring geographical region when the vessel crosses a threshold distance within the buffer area of the first tile data and the second tile data.

Each layer in the tiled data can represent a collection of data of the same type and may contain data from different data sources. The data in each layer may represent real-world features (e.g., waterway maps), navigation aid and rules, environmental data (e.g., water depth, wind speed and direction, etc.), occupancy grid, static and dynamic objects, etc. In some embodiments, tile data may use a dedicated data processing pipeline accessible by a dedicated application programming interface (API). Depending on the application for which the data is used, a user or the automated vessel can subscribe to or request on-demand subsets of the data and therefore can access only relevant layers within the tiled data.

Consequently, the tiled data can be gathered from various data sources, for example from the sensors on the autonomous vessel or sensors on static entities that are geographically fixed along the waterway. The data is then stored and maintained in an intelligent manner by being distributed between edge nodes and stored in a cloud processing unit. As such, the data can then in a timely manner be provided appropriately for the autonomous vessel to execute its mission task. The data sources may form data for the various layers of the layered tiled data. Tiled data can include data received from data sources such as other vessels or navigational or environmental sensors fixed along the waterway of dynamic objects such as the geographic position, heading, and speed of other vessels on the waterway.

Tile data in each tile also includes data associated with the most important objects in adjacent tiles, including data related to other vessels on the waterway. Such an arrangement allows for planning of a path for the automated vessel to pre-fetch data that is likely to be critical for the mission planning in the near future and store the pre-fetched data on an edge node close to the vessel or in the local cache of the vessel, depending on real-time requirements with respect to the given data entity.

In some embodiments, computing resources may be shared between the autonomous vessels and the edge nodes that are accessible to the autonomous vessel. In particular, the autonomous vessel can be notified of a subset of accessible edge nodes that have available computing resources. The autonomous vessel can the perform data collection, estimate the required computing resources to be used to accomplish its mission task, and apply for migrating part of the calculations and/or data storage to the subset of available edge computing node. In some embodiments, essential objects that are important to critical planning for achievement of the mission task may help determine which edge computing nodes to activate to partially perform computations to determine parameters.

As discussed above, the autonomous vessel is equipped with a suite of sensor platforms. In some embodiments, at least some of the sensor platforms can independently identify objects around the vessel, which can be compared with the objects indicated in the tiled data. In some cases, the data from several sensor platforms can be combined in a sensor fusion process, using a probabilistic data fusion approach, to better identify objects and their locations around the vessel. In some embodiments, an object tracking component, for example for tracking other vessels in the waterway, in an object tracking component.

As discussed above, the autonomous vessel is equipped with sensor systems that can include, for example, global positioning sensors, cameras located on the front, rear, and sides of the vessel, lidar arranged similarly to the camera sensors, ultrasonic sensors, radar sensors, sonars, and various other sensors that allow collection of data that allow identification of features in the waterway, the vessel position in the water, identification of other mobile objects (e.g., other vessels) in the waterway, navigational hazards, and other information.

In some embodiments, the identification and tracking of objects such as other vessels on the waterway can be assisted by receipt of data from edge nodes indicating those objects in neighboring tiles.

Consequently, a method for controlling an autonomous vessel can include receiving sensor data from sensors mounted on the autonomous vessel and the tiled data associated with tiles corresponding to the geographic location of the autonomous vessel; performing object detection by an object detection component associated one or more of the sensors; fusing the object detection results and calculating a fused probability score for each detected object; and using the fused object detection scores for tracking of the objects.

In some embodiments, the system for autonomous vessel control can include sensor data receivers configured to receive sensor data collected by a plurality of autonomous vessels and/or sensors associated with objects in the waterways, a fusion block that is configured to perform fusion of received sensor data, data storage to store received sensor data and layered tiled data in a mapping database, computational processing configured to retrieved the sensor data and layered tiled data to compute parameters to operate the autonomous vessel, and communications for communicating data between the autonomous vessel and one or more edge nodes. As discussed above, the layered tiled data relates to a geographic tile where the group of tiles divides the large physical geographic area into tile areas. The tiles can be any geometric shape that, when contiguously arranged, can span the geographic region.

In some embodiments, an autonomous vessel can include one or more sensors, a computational unit configured to receive layered tiled mapping data based on the geographic location of the autonomous vessel, and vessel drivers to operate the autonomous vessel, wherein the computation unit predicts computational resources required to predict operation of the autonomous vessel through the vessel drivers to accomplish a mission task.

Consequently, embodiments of the present invention address the problem of controlling autonomous vessels within inland waterways in an efficient manner with low latencies. The problem is solved by organizing data in a layered tiled format as discussed above where the tiled data is gathered from a plurality of data sources, including sensors on autonomous vessels transiting the area of each tile. There further includes specific interrelations between tile data of adjacent tiles. An edge infrastructure is utilized that provides computational resources for computing parameters that are used to control the autonomous vessels. Additionally, there is pre-fetching to allow acquisition of data and resources that will be used to control the autonomous vessel in the near future.

In particular, tile data in a tile stores information about the most important entities in adjacent tiles, allowing a mission planning component to pre-fetch data that is likely to be critical for the mission planning in the nearby future and store the pre-fetched data on an edge node close to the vessel or in the vessel's local cache depending on real-time requirements with respect to the given data entity. Thus, data that is considered critical for the mission task is always available and stored at a location that is close to the that of the autonomous vessel. This planning component, therefore, significantly reduces latency because long data transactions with a central cloud server are avoided and the data is configured to address individual geographic locations. Having layered tiled data stored in individual edge nodes that service the geographic area of the corresponding tile in which the autonomous vessel is currently operating, and access to tile data from adjacent tiles, greatly reduces the latency in controlling the autonomous vessel.

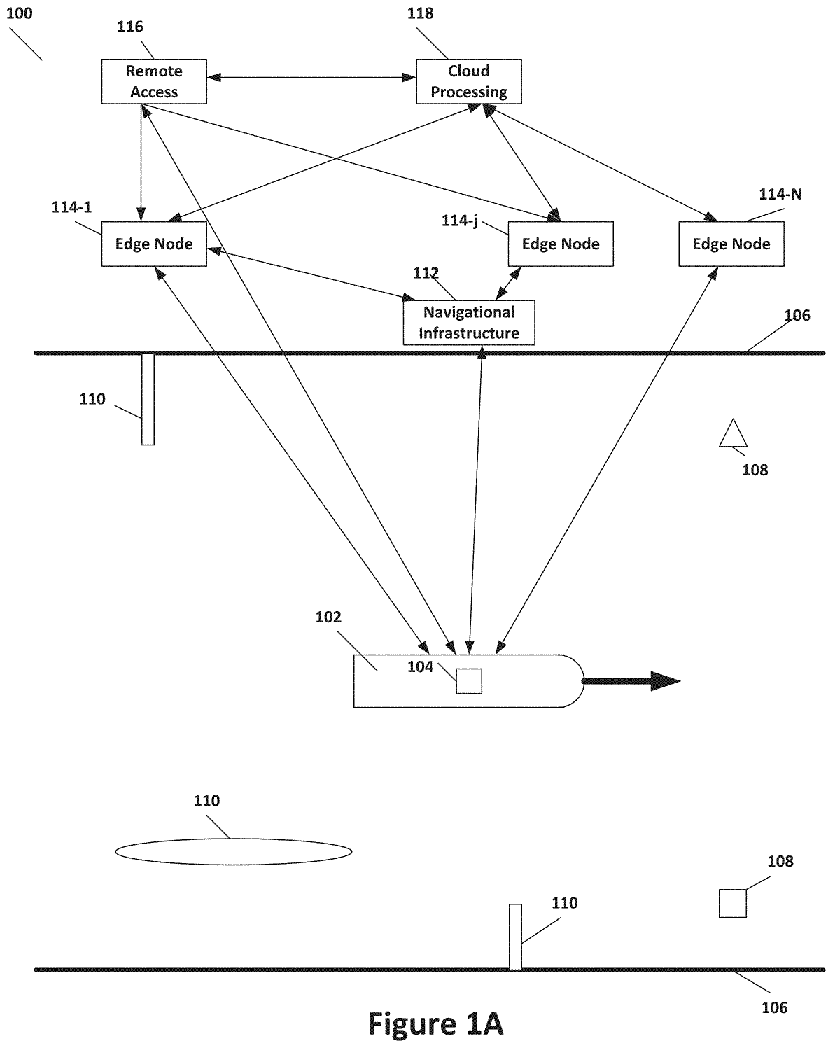

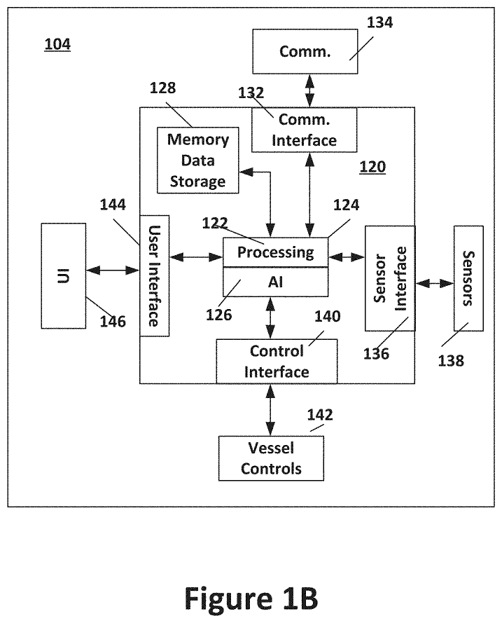

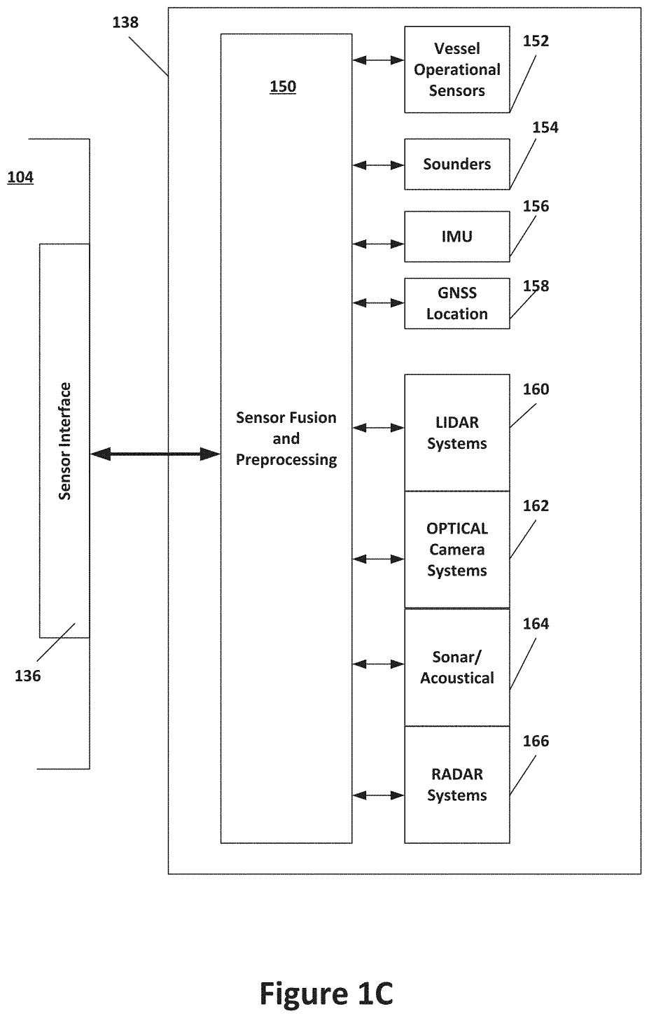

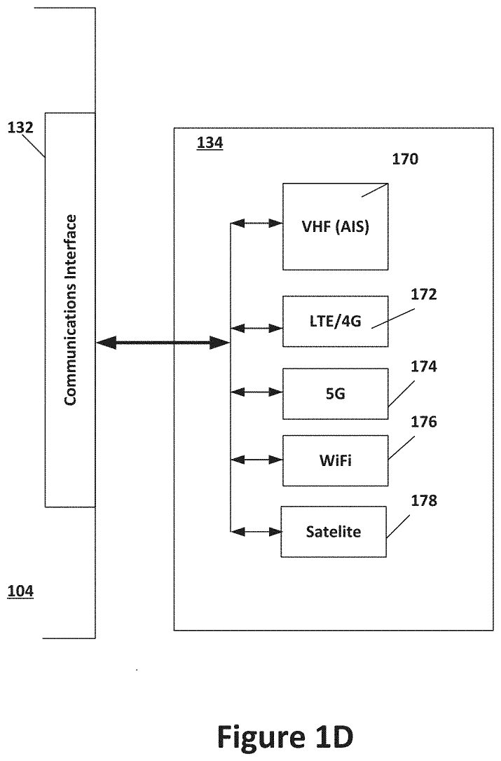

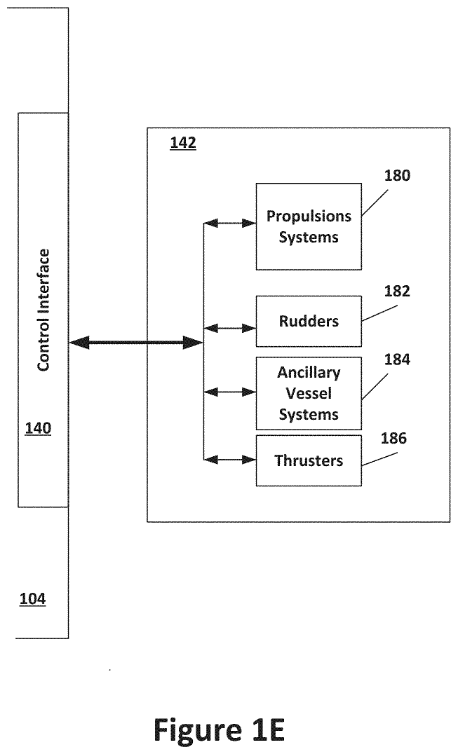

FIG. 1A illustrates a computational environment 100 for control of an autonomous vessel 102 that is traversing through the waterway according to some embodiments of the present disclosure. As illustrated in FIG. 1A, autonomous vessel is traversing a waterway with banks 106, navigational markers 108, and obstructions 110. Navigational markers 108 designate boundaries of a navigation channel in the waterway (waterway location data) defined by banks 106. Obstructions 110 represent objects such as shoals or sand banks, wharfs, or other permanent or semi-permanent objects in the waterway.

As is further illustrated in FIG. 1A, one or more edge nodes 114-1 through 114-N, of which edge node 114-j is an arbitrary one of edge nodes 114, are arranged geographically along the waterway. Edge nodes 114 can be located anywhere that communications with autonomous vessel 102 has a low enough latency to provide good control of autonomous vessel 102. For example, edge nodes 114 may be positioned along banks 106 of the waterway, however installations that are further distant may also be possible.

As is illustrated in FIG. 1A, at least a subset of edge nodes 114 are in communications with a control unit 104 on autonomous vessel 102. Further, communications between edge nodes 114 and autonomous vessel 102 may include intermediaries such as cell phone towers or other infrastructure that allow such communications. Control unit 104 includes sensors, communications, and vessel control apparatus that allow communications with edge nodes 114 as well as other autonomous vessels that share the waterway and with other navigational infrastructure 112. For example, navigational infrastructure 112 may include sensors (e.g., cameras, lidar, radar, or other available sensors), beacons (e.g., GNSS RTK augmentation or other positioning beacons), and communications capability to provide data from geographically fixed locations.

As discussed above, each of edge nodes 114-1 through 114-N includes layered tiled data that are appropriate for a geographic area in which autonomous vessel 102 is operating. The geographic area may be serviced by one or more of edge nodes 114-1, which includes the tiled data appropriate for that geographic area. The parameters for control of autonomous vessel 102 (e.g., location, heading, and speed) can be computed with computational resources derived from one or more of edge nodes 114 and control unit 104.

As is further illustrated in FIG. 1A, a remote access 116 can communicate with edge nodes 114 or directly with control unit 104 of autonomous vessel 102. Remote access 116 provides access to remotely control autonomous vessels 102, monitor the process of autonomous vessel 102, or redefine a mission task of autonomous vessels 102.

Further, edge nodes 114 may communicate with a central cloud processing unit 118. Cloud processing unit 118 may compile the tiled data from each of edge nodes 114, especially after it has been updated by one or more edge nodes 114. The tiled data can be centrally stored at cloud processing 118 and updated to edge nodes 114 periodically so that the tile data stored in each of edge nodes 114 remains up to date.

FIG. 1B illustrates an example of control unit 104. Control unit 104 is installed on autonomous vessel 102 and control the physical operation of autonomous vessel 102. As illustrated in FIG. 1B, control unit 104 includes a processing block 124. Processing block 124 includes any combination of computers, microcomputers, microprocessors, application specific circuits, general processing units (GPUs) or other computing devices. As illustrated in FIG. 1B, processing block 124 can be segregated into a digital processing block 122 and a neural network or AI block 126. In some embodiments, AI block 126 may include dedicated analog circuitry that depends on trained parameters to provide an output based on a set of input parameters. In general, processing block 124 at least includes sufficient computation resources to perform the functions described in this disclosure. AI block 126 may, for example, determine particular control parameters to control autonomous vessel 102 from parameters that are related to control of the vessel to accomplish the mission task of the autonomous vessel 102.

Processing block 124 is coupled to a memory block 128. Memory block 128 includes both volatile and non-volatile memory that stores instructions to be executed by processing block 124, parameters that control the operation of processing block 124, and instructions that are executed by processing block 124 to perform the functions described in this disclosure. Member block 128 includes memory of sufficient size to store the data and instructions for performing the functions described in this disclosure. Memory block 128 may further include removable data storage on which logging data or other functions may be recorded and through which updates to data and instructions can be provided.

As is also illustrated in FIG. 1B, processing block 124 may be coupled to a user interface 144 to interact with a user interface accessible by personnel that are maintaining, monitoring, or crewing autonomous vessel 102. User interface 144 may include any combination of monitors, touch screens, keyboards, pointing devices, cameras, or other data input or data displays that allow interaction with control unit 104. In some embodiments, user interface 144 may include USB or other data input interfaces that allow data input or data recordation from control unit 104. In some embodiments, user interface 146 may be removable from control unit 104 and supplied only when interaction with service personnel is occurring.

As is further illustrate, processing block 124 may provide data communications through communication interface 132 to communications block 134. Any form of communications can be used, including wireless communications, VHF communications, cell phone communications, etc. Communications block 134 is configured to receive data from and transmit data to edge nodes 114, navigational infrastructure 112, other autonomous vessels, or any other entity.

Processing block 124 is further coupled to a sensor interface 136 that is coupled to receive data from sensor block 138 that are arranged around autonomous vessel 102. Sensors 138 includes any number of sensors that, in combination, allow autonomous vessel 102 to sense objects in its vicinity and detect its geographic location and orientation. Any combination of sensors can be used. As discussed above, sensor data received from sensors 138 can be communicated with edge nodes 114 through communications block 134.

Processing block 124 is further coupled through control interface 140 to vessel controls 142. Vessel controls 142 control the operation of autonomous vessel 102, including engine controls, rudder controls, controls for any thrusters that may be present. Further, the controls may include controls for other systems such as bilge pumps, load balancing, lighting, automated docking systems, or other systems that may be on board autonomous vessel 102.

FIG. 1C illustrates an example of sensor block 138. As discussed above, sensor block 138 interacts with control unit 104 through sensor interface 136. Sensor block 138 can include, for example, vessel operational sensor 152, sounders 154, inertial motion units (IMUs) 156, Global Navigational Satellite System (GNSS) receivers 158, light detection and ranging (LIDAR) systems 160, optical/IR camera systems 162, sonar/acoustical systems 164, and radar systems 166. Vessel operation sensors 152 can include sensors for monitoring the operation of the autonomous vessel, including propulsion performance sensors (temperature, oil pressure, encoders, battery charge), vessel speed, vessel heading, rudder positions, bilge water sensors, loading, or other parameters related to operation of autonomous vessel 102. In some embodiments, the propulsion system may be fossil fuel based (diesel, gasoline), however other propulsions systems can be electrically driven powered by battery charge, fuel cells, and other systems. Propulsion performance sensors can, therefore, include sensors indicating fuel levels, charging levels, performance of charging systems (solar, wind, etc.) and other data.

Sounders 154 monitor depth under autonomous vessel 102. IMUs 156 monitor inertially the motion of autonomous vessel 102. GNSS receivers 158 determine the geographic location of autonomous vessel 102 as well as the speed-over-ground (SOG) and heading of autonomous vessel 102. LIDAR systems 160, optical/IR camera systems 162, sonar/acoustical systems 164, and radar systems 166 can help detect and identify objects around and beneath autonomous vessel 102.

As is further illustrated in FIG. 1C, each of sensor blocks 152-166 can be coupled to a sensor fusion and preprocessing block 150. Sensor fusion and preprocessing block 150 receives data from sensor blocks 152-166 and processes the data. For example, in some embodiments data from LIDAR systems 160, camera systems 162, acoustical block 164, and RADAR systems 166 can be fused using a probabilistic scoring or using an AI process to provide better identification of objects in the waterway. In some embodiments, sensor fusion and preprocessing block 150 includes data processing circuits to digitize data and interface through sensor interface 136. In some embodiments, object identification and tracking can be accomplished in individual sensor blocks or in preprocessing block 150. Data received from tile data regarding objects can be used to help identify objects.

FIG. 1D illustrates communications block 134 and communications interface 132. As is illustrated in FIG. 1D, communications block 134 can use any form of communications, including VHF 170, LTE/4G 172, 5G 174, WiFi 176, or satellite communications 178, for example. VHF 170, for example, can include an automatic identification system (AIS) that provides the location, heading, and speed of other vessels in the vicinity that are similarly equipped, as well as transmit its own. Satellite communications 178 can include, for example, communications with low earth orbit (LEO) constellations such as the Starlink system. It should be noted that communications block 134 can include other forms of communication as well and the one components illustrated are exemplary only. Digital data can be transmitted to and received from edge nodes 114 through communications block 134.

FIG. 1E illustrates vessel control block 142. As illustrated, vessel control block 142 includes engine controls 180, rudder controls 182, ancillary vessel system controls 184, and thruster controls 186. In essence, vessel control block 142 allows control unit 104 to control all aspects of the operation of autonomous vessel 102, including the speed and heading of the vessel. Further, ancillary systems such as bilge water levels, load levels, vessel lighting, or other systems can be controlled.

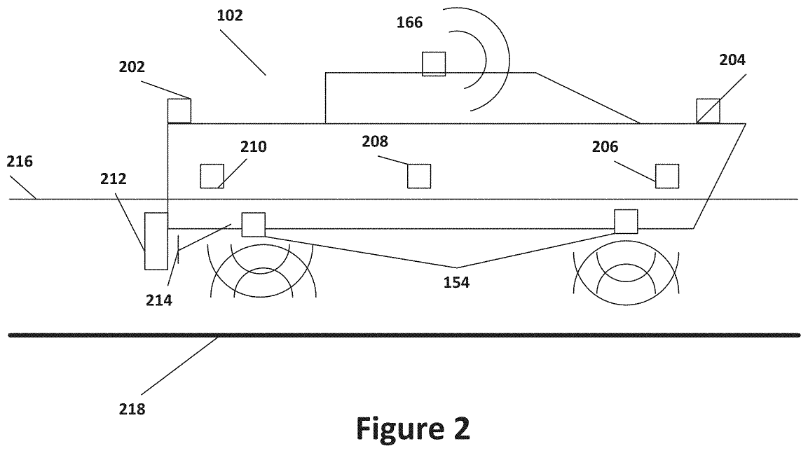

FIG. 2 illustrates placement of sensors on autonomous vessel 102. An autonomous vessel 102 can be any vessel, of any size, that includes a propulsion system that controls speed, a steering system that controls heading, a data acquisition system, and a control system that can control aspects of the propulsion system and/or steering system according to data from the data acquisition system. In the particular example illustrated in FIG. 2, autonomous vessel 102 includes rudder 212 and propeller 214 coupled to an engine (not shown). A rudder and driven propeller system provides an example, other propulsion systems and steering systems can be used. As is further illustrated in FIG. 2, multiple sounders 154 can be mounted on the hull below the water line 216 to monitor and determine water depth between the water line 216 and bottom 218. Further, cameras, Lidar, and radar systems can be mounted fore and aft, as indicated by sensor blocks 202 and 204. A separate radar 166 may be mounted at a high point on autonomous vessel 102. Further, sensors 206, 208, and 210 may be mounted along the sides. Sensors 206, 208, and 210 may be any combination of acoustical, LIDAR, camera systems, radar, or other systems to detect and identify objects to the sides of autonomous vessel 102.

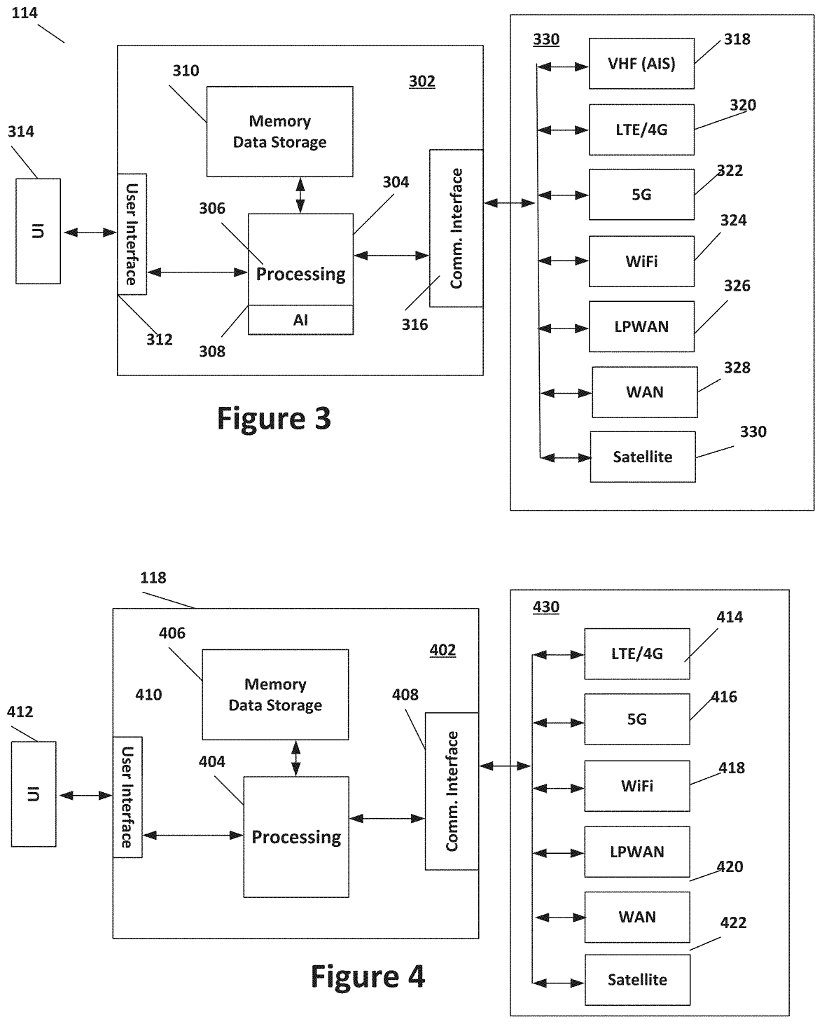

FIG. 3 illustrates an example of an edge node 114. As illustrated in FIG. 3, edge node 114 includes a controller 302 that includes a processing unit 304. Processing unit 304 may include any combination of computers, microcomputers, microprocessors, application specific circuits, graphics processing units (GPUs) or other computing devices. As illustrates in FIG. 3, processing unit may include digital processing 306 and may further including an AI 308, which may be a neural network. AI inference computational tasks (e.g., using neural networks to process video, lidar, or other data) can be performed on several different processing units such as a GPUs, field programmable gate arrays (FPGAs), vision processing units (VPUs), tensor processing units (TPUs), or other such processors. Processing unit 304 includes computational resources capable of performing the tasks described in this disclosure for edge nodes 114.

Processing block 304 is coupled to a memory storage block 310. Memory storage block 310 includes volatile and non-volatile memory capable of storing data and instructions for performing the functions of edge node 114. In particular, layered tile data appropriate to a particular geographic area that is serviced by edge node 114 is stored in memory storage block 310. As is further discussed in this disclosure, the tile data stored in memory storage block 310 may be updated periodically to reflect sensor data received from autonomous vessels 102 and updated tile data uploaded to cloud processing 118 and shared with other edge nodes 114.

As is further illustrated in FIG. 3, processing unit 304 is coupled through a communications interface 316 to a communication block 330, which may include one or more of VHF block 318, LTE/4G block 320, 5G block 322, WiFi block 324, a low-powered wide-area network (LPWAN) block 326, a wired wide-area network (WAN) block 328, and a satellite communication system 330. Consequently, edge node 114 may have multiple channels with which to communicate with autonomous vessels, with other edge nodes, and with cloud processing 118.

In some embodiments, processing block 304 may further be coupled to a user interface 314 through an interface 312. User interface 314 may include any combination of monitors, touch screens, keyboards, pointing devices, or other data input or data displays that allow interaction with edge no. In some embodiments, user interface 314 may include USB or other data input interfaces that allow data input or data recordation from control unit 302.

As discussed above, tile data for a geographic area serviced by edge node 114 is stored in data storage 310. The tile data may be used in computational processes executed on processing unit 304 to determine parameters for controlling a target autonomous vessel such as autonomous vessel 102 or the tile data may be transmitted to autonomous vessel 102 in anticipation of obtaining operating parameters for control of autonomous vessel 102. In some embodiments, multiple ones of edge nodes 114 may include a particular tile data and edge nodes 114 may service overlapping geographic areas. In some embodiments, edge node 114 may update tile data according to sensor data received from autonomous vessels or other fixed sensors. Updated tile data may be uploaded to cloud processing 118 to update all edge nodes 114 that share that tile data.

FIG. 4 illustrates an example of a cloud processing unit 118 according to some embodiments. As illustrated in FIG. 4, cloud processing unit 118 includes a controller 402 processing block 404 and data storage 406. Processing block 404 may include any combination of computers, microcomputers, microprocessors, application specific circuits, graphic processing units (GPUs) or other computing devices. Processing block may also use AI processors. AI inference computational tasks (e.g., using neural networks to process video, lidar, or other data) can be performed on several different processing units such as a GPUs, field programmable gate arrays (FPGAs), vision processing units (VPUs), tensor processing units (TPUs), or other such processors. As illustrates in FIG. 4, processing unit 404 includes computational resources capable of performing the tasks described in this disclosure for cloud processing 118.

Data storage 406 includes volatile and non-volatile memory capable of storing data and instructions for performing the functions of cloud processing 118. In particular, the layered tile data that covers the geographic region of operation of autonomous vessel 102 is stored in data storage 406. Cloud processing 118 receives updated tile data from individual ones of edge nodes 114, stores the complete mapping data with all of the tile data, and downloads updated tile data to individual ones of edge nodes 114 that is appropriate for the geographic area serviced by each of the edge nodes 114. In particular, updated tile data may include updated tiled data indicating permanent feature placement in the tile. Updated tile data does not include transient object data such as that related to vessels traversing the tile.

As is further illustrated in FIG. 4, processing unit 304 is coupled through a communications interface 408 to a communication block 430. Communication block 430 includes any communications system that allows communications with edge nodes 114. These communications systems, as illustrated in FIG. 4, may include one or more of LTE/4G block 414, 5G block 416, WiFi block 418, a low-powered wired wide-area network block 420, a wired wide-area network block 422, and satellite communications 422. In many cases, cloud processing 118 may be more conveniently coupled with edge nodes 114 through conventional wired networks. Consequently, cloud processing 118 may have multiple channels with which to communicate with autonomous vessels 102, with other edge nodes, and with cloud processing 118.

Cloud processing 118 may further include an interface 410 to a user interface 412. User interface 412 may include any combination of monitors, touch screens, keyboards, pointing devices, or other data input or data displays that allow interaction with control unit 402. In some embodiments, user interface 412 may include USB or other data input interfaces that allow data input or data recordation from control unit 402.

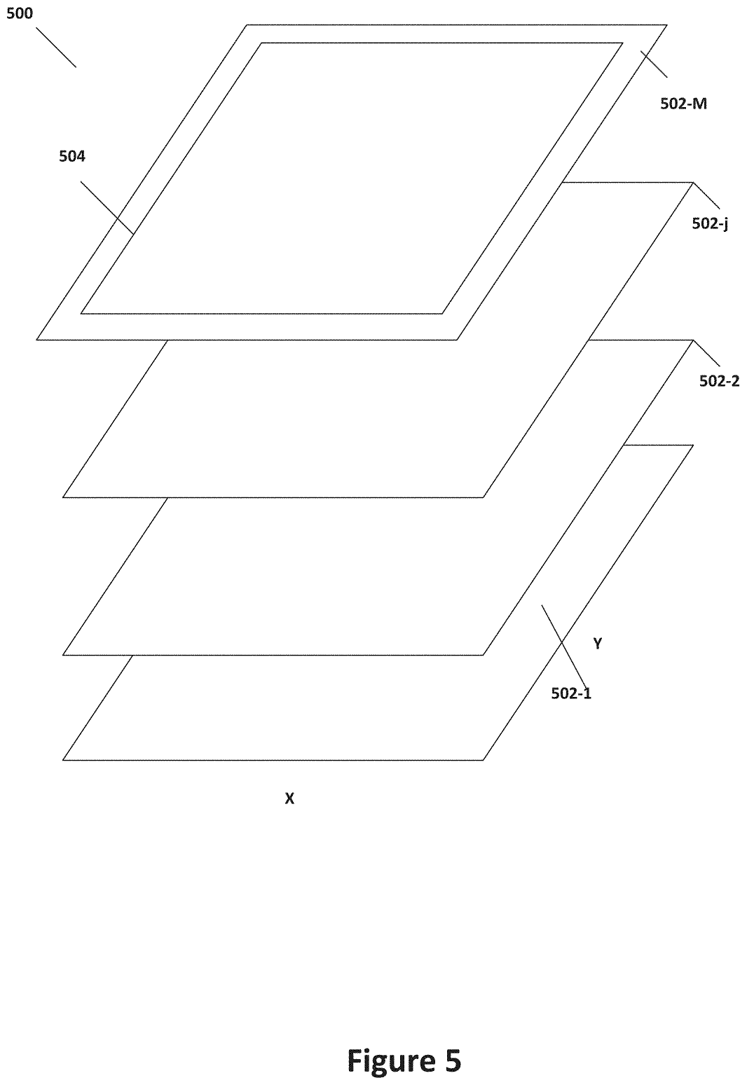

FIG. 5 illustrates a tiled data 500 according to some embodiments. Tiled data 500 is associated with a geographic tile 504. Geographic tile 504 is defined by its geographic area bound in the horizontal plane. As illustrated in FIG. 5, tile data 500 may include data for features enclosed in geographic tile 504 and further within a buffer area around geographic tile 504. Geographic tile 504, for example, can be a square area defined by X and Y boundary coordinates. The X-Y coordinates of tile data 500 covers the X-Y area defined by tile 504 with a buffer area. As is further illustrated above tile 504 can take on any shape such that the collection of tiles 504 span a geographic area covered by the entire geographic map formed by combining all of the tiled data.

As is further illustrated in FIG. 5, tiled data 500 is layered and includes data layers 502-1 through 502-M. Each layer of data refers to data with regard to the same geographic location with reference to tile 504 that provides feature qualities describing objects, features, and environmental conditions with regard to tile 504. The layers can be derived from various data sources. In particular, the data sources can, for example, include the data sensors aboard a particular autonomous vessel 102, stationary sensor platforms that are part of the infrastructure, previously performed surveys (e.g., data from other vessels, bathymetry), and computed layers the provide predicted data (tide levels, other vessels—location, heading, speed, and other data). For example, as discussed above, the layers can include one or more of the following layers that are derived from different data sources and indexed to the geographic coordinates:
Electronic Chart Display and Information System (ECDIS) mappings can be imported with all navigational information regarding the waterways in the geographic region (lanes, speed limits, width/height restrictions, lights, lighthouses, buoys, cardinal markings);
Point cloud mappings acquired from lidar-based localization of autonomous vessels or from other methods such as stationary or mobile scanning platforms;
3D mappings of permanent and semi-permanent features of the waterways, including banks, riverbeds, locks, bridges, damns, mooring dolphins, bollards, quay sides, warfs, jetties, port and marina areas, and other features taken from video sources on autonomous vessels, stationary sensors, or other sources;
Environmental data that includes water depths, tidal information, current, wind, visibility, temperature, and other data that may be measured from sensors on autonomous vessels, sensors on infrastructure adjacent the waterway, or pre-computed data received from authorities responsible for providing that data;
Infrastructural data that includes bridge position, locks, berthing occupancy, construction works, geo-fenced areas, or other data; and
Transient data such as traffic data that includes vessels and other objects on water processed by sensor fusion of multiple different data points on autonomous vessels or other sources.

The 3D mappings can, for example, be Red-Green-Blue (RGB) colorized video data, segmented, and classified geo-referenced. In some embodiments, the segmentation can be performed by known deep learning methods, such as convolutional neural network artificial intelligences (AIs). These data elements can then be stored in the distributed data store as layered tiled data using the edge node infrastructure. Embodiments of the present disclosure utilize this infrastructure and the specific manner in which data is stored and used in the infrastructure to allow the autonomous vessel to complete its mission task.

In an example of a layering structure, data layers 502 can include an infrastructure data layer, environmental layers, semantic and navigational layers, geometry layers, and base map layers. The infrastructure data layers may include, for example, waterway sensor data and metadata on bridge positions, locks, berthing occupancy, VHF channels, and responsible authorities. Infrastructure data layers may also include details regarding construction work areas. Environmental layers include past, current, and predicted environmental conditions. These environmental conditions include, for example, tidal information, river current speed/direction per location (measured and estimated), wind (direction, speed), visibility, temperature, humidity, precipitation, and insolation. Semantic and navigation layers can include segmented point cloud, waterway boundaries, crossings and waterway intersections, mooring/docking positions, fairway rules and regulations, signs and signals on the water and bank marks, and geo-fenced areas (e.g., private property). Geometry layers can include geo-referenced point clouds and geo-referenced geometries (e.g., collection of 3D meshes or 3D objects) of riverbank, sea/river bed, locks, bridges, damns, mooring dolphins, bollards, quay sides, wharfs, jetties, port and marina areas. Base map layers include electronic navigational charts (ENC), GIS maps/layers, BIM models, and other 2D maps.

In some embodiments, tile data 500 may include data for primary features that are present in tiles that are adjacent to tile 504. Further, tile data 500 may be appended to include data regarding features and objects from tiles in which an autonomous vessel 102 is expected to traverse in the near future. Additionally, one of the layers 502 of tile data may be related to transient objects such as other vessels that are also traversing the waterway. Edge node 114 may detect such transient objects through AIS, sensor data from automated vessels that has been received in one of edge nodes 114, sensor data from sensors that are installed on fixed maritime infrastructure adjacent to waterway 112 or from other sources.

Tile data 500 for a collection of tiles 504 that represent a geographic area serviced by a particular edge node 114 can be stored in the edge node. Such data may, in some cases, be downloaded to an autonomous vessel 102 where it is used to make operational decisions regarding the parameters for controlling the autonomous vessel 102. In some embodiments, the operational decisions can be made using computation resources of the autonomous vessel 102 and one or more edge nodes 114 using tile data 500.

The collection of all tile data 500 may be uploaded and stored in cloud processing 118. Edge nodes 114 may update tile data 500 based on sensor data from one or more autonomous vessels 102. Since multiple ones of edge nodes 114 may include tile data 500 for the same tile 504, such updates may be uploaded to cloud processing 118 and edge nodes 114 updated appropriately.

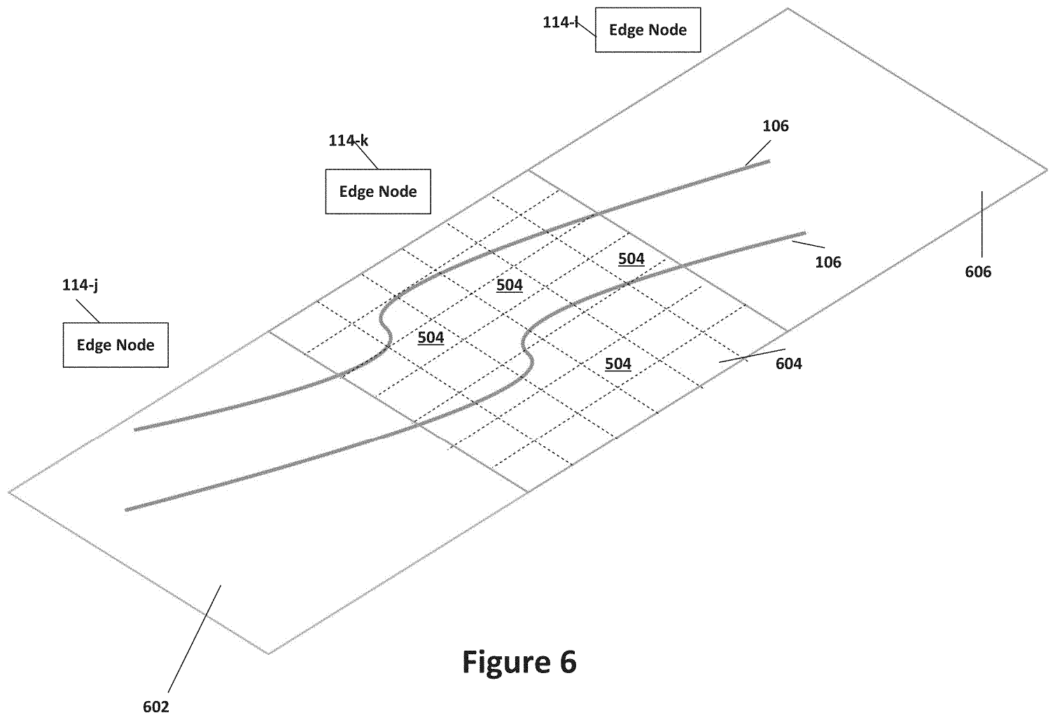

FIG. 6 illustrates tile arrangements according to some embodiments. As illustrated in FIG. 6, the waterway is indicated by banks 106. Regional areas 602, 604, and 606 are illustrated. As indicated. Edge node 114-j covers regional area 602, edge node 114-k covers regional area 604, and edge node 114-1 covers regional area 606. Any number of edge nodes 114 may be present covering different, possibly overlapping, regional areas. As an autonomous vessel 102 traverses the waterway, it will transition between edge nodes 114 that cover different areas. As is further illustrated in FIG. 6, tiles 504 associated with regional area 604 are represented. Edge node 114-k, consequently, stores tile data 504 associated with regional area 604.

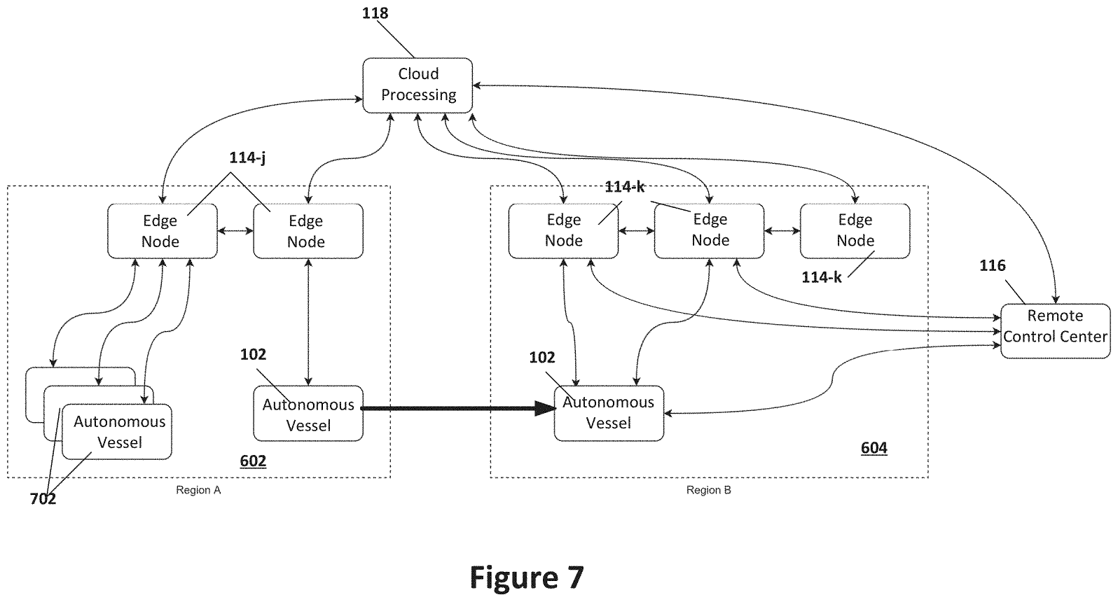

FIG. 7 illustrates further the transition of autonomous vessel 102 as it transitions between regional area 602 and regional area 604. As illustrated in FIG. 7, autonomous vessel 102 transitions from regional area 602 to regional area 604. In regional area 602, autonomous vessel 102 communications with edge node 114-j (represented by two separate edge nodes in FIG. 7). Edge node 114-j further communications with other autonomous vessels 702 that are in geographic region 602. When autonomous vessel 102 enters region 604, it switches communications to edge nodes 114-k (represented by three separate edge nodes in FIG. 7). During transition, autonomous vessel 102 may request computational services from edge nodes 114-k in anticipation of computation of the parameters that control operation of autonomous vessel 102. FIG. 7 further illustrates communication with cloud processing 118 and with a remote-control center 116.

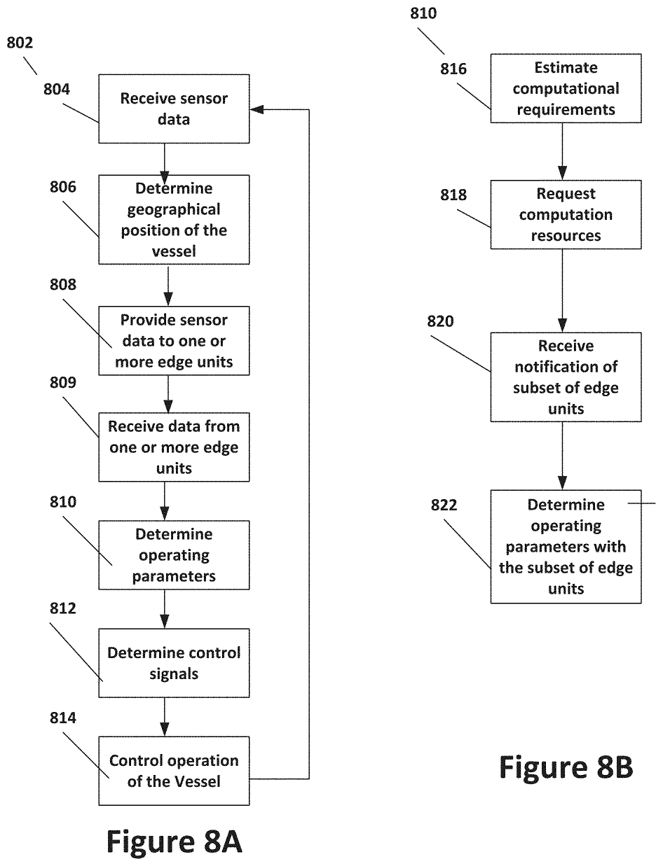

FIGS. 8A and 8B illustrate example algorithms for operating autonomous vessel 102. In some embodiments, autonomous vessel 102 may compute all operating parameters in control unit 104. However, in some embodiments, the computational load for determining operating parameters may be partially or completely shifted to one or more edge nodes 114 that cover the geographical area being transited by autonomous vessel 102.

FIG. 8A illustrates an algorithm 802 that can be executed on control unit 104 for controlling autonomous vessel 102. In step 804, control unit 104 receives sensor data from sensors 138 mounted on autonomous vessel 102. As discussed above, the sensor data is received from a plurality of sensor systems 138 that are distributed on vessel 102, the plurality of sensors 138 collecting sensor data related to objects adjacent the vessel, at least one of the plurality of sensor systems 138 determining a geographic location of the vessel. In step 806, the geographical location of the vessel is determined. In step 808 the sensor data is provided to one or more edge nodes 114 in communication with vessel 102, the one or more edge nodes 114 associated with the geographic location of vessel 102. In step 809, control unit 104 can receive data from one or more edge nodes 114. In some cases, the data received can be tiled data, including pre-fetched data from neighboring tiles. In some cases, the data received can be operating parameters or a partial computation of the operating parameters. In some embodiments, the data received includes the transient data layer from the tiled data that helps control unit 104 to identify and anticipate objects such as other vessels that are transiting the geographic area.

As a particular example, if a pleasure craft is detected in a neighboring tile into which autonomous vessel is transiting, then the transient layer of the tiled data that indicates that pleasure craft can assist control unit 104 in verifying the course of that pleasure craft and the planning algorithm resulting in operating parameters can be better implemented to avoid the expected path of the pleasure craft.

In step 810, operating parameters to perform a mission task is determined in a planning operation. The operating parameters are based on tiled data 500 from the one or more edge nodes and the sensor data, the tiled data 500 associated with the geographical position of the vessel, the tiled data including data associated with feature objects within the geographic area associated with the tiled data 500 as well as transient data regarding other vessels transiting the area. In some embodiments, the operating parameters are calculated by control unit 104. In some embodiments, the operating parameters are calculated by one or more edge nodes. In step 812, control signals are determined from the operating parameters. The control signals are actual signals sent to systems on vessel 102 to control operation of vessel 102. In step 814, the control signals are provided to a vessel control array, the vessel control array configured to control vessel heading and speed according to the control signals.

FIG. 8B illustrates an example algorithm 810 for determining operating parameters. As illustrated in FIG. 8B, control unit 104 first estimates computational requirements for determining the operating parameters in step 816. In step 818, control unit 104 requests the computational resources based on the requirements determined in step 816. In step 820, control unit 820 receives notification of a subset of available edge nodes that have the computation resources. In step 822, the operating parameters are determined using the subset of available edge nodes.

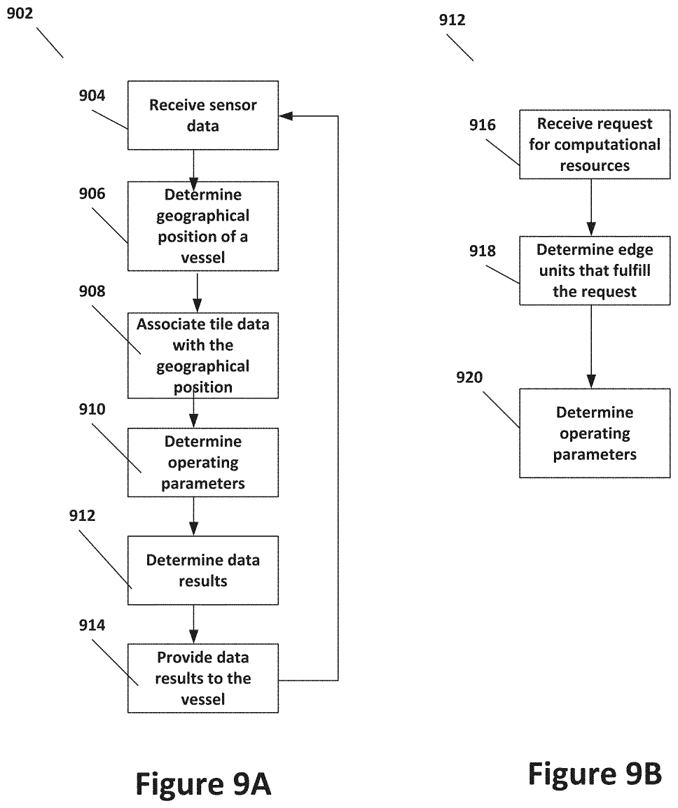

FIGS. 9A and 9B illustrate operation of an edge node 114 according to some embodiments. FIG. 9A illustrates an example algorithm 902 for operation of an edge node 114. In step 904, edge node 114 receives sensor data from vessel 102. In step 906, the geographical position of vessel 102 is determined. In step 908, the appropriate tile data is associated with the geographical position. In step 912, a set of data results is determined for transmission to vessel 102. In step 914, the data results are transmitted to the vessel 102. In some embodiments, the data results are the tile data. In some embodiments, the data results are operating parameters for control of vessel 102.

FIG. 9B illustrates an example determination of data results 912 that include the operating parameters. In step 916, edge node 114 receives a request for computational resources from vessel 102. In step 918, edge node 114 determines which edge nodes are available to fulfill the computational request and reports to vessel 102. In step 920, operating parameters are determined using the available computational resources.

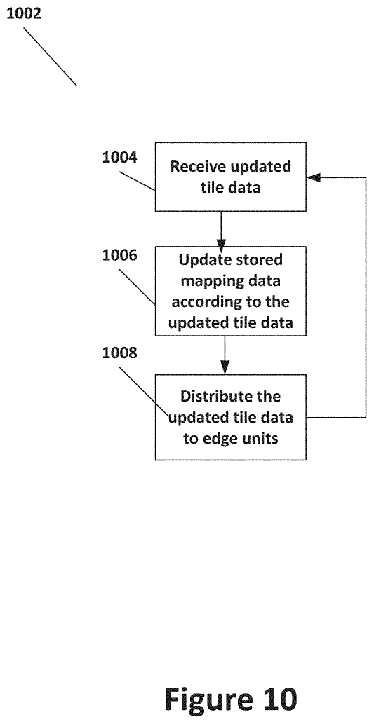

FIG. 10 illustrates an algorithm 1002 for operation of a cloud processing unit 118 according to some embodiments. In step 1004, cloud processing unit 118 receives updated tile data from one or more edge nodes 114. In step 1006, cloud processing unit 118 updates the stored mapping data according to the updated tile data. In step 1008, cloud processing unit 118 distributes updated tile data to edge nodes that include that tile data.

The above detailed description is provided to illustrate specific embodiments of the present invention and is not intended to be limiting. Numerous variations and modifications within the scope of the present invention are possible. The present invention is set forth in the following claims.

What is claimed is:

1. A control system on a vessel, comprising:
a plurality of sensor systems distributed on the vessel, the plurality of sensors collecting sensor data related to objects adjacent the vessel, at least one of the plurality of sensor systems determining a geographic location of the vessel;
a communications system configured to communicate with one or more edge nodes, the one or more edge nodes associated with the geographic location of the vessel;
a vessel control array, the vessel control array configured to control vessel heading and speed according to control signals;
an on-board processing unit, the on-board processing unit coupled to the plurality of sensors, the communications system, and the vessel control array, the on-board processing unit executing instructions to
receive sensor data from the plurality of sensor systems;
provide the sensor data to the one or more edge nodes;
receive tiled data from one or more edge nodes;
determine operating parameters to perform a mission task based on tiled data from the one or more edge nodes and the sensor data, the tiled data associated with a current geographical location of the vessel, the tiled data including data associated with feature objects within the geographic area associated with the tiled data,
provide control signals based on the operating parameters to the vessel control array; and
provide data from the plurality of sensor systems to the one or more edge nodes.

2. The control system of claim 1, wherein the instructions to provide the operating parameters includes instructions to
receive a tiled data associated with the geographic location of the vessel from the one or more edge nodes,
determine location of substantial objects from the tiled data;
compare the substantial objects with objects detected from the plurality of sensors;
plan an operation based on the comparison and the mission task of the vessel; and
determine a sequence of operating parameters to execute the planned operation.

3. The control system of claim 1, wherein the instructions to provide the operating parameters includes instructions to
determine a subset of the one or more edge nodes to calculate a sequence of operating parameters to execute a planned operation consistent with the mission task; and
receive, from the subset, a sequence of operating parameters.

4. The control system of claim 1, wherein instructions to determine operating parameters includes instructions to
determine a subset of the one or more edge nodes;
receive a partial computation of the operating parameters from the subset of the one or more edge nodes; and
determine operating parameters from the partial computation.

5. The control system of claim 1, wherein the tiled data is associated with a tile within a geographical area where the vessel operates, the collection of tiles arranged to span the geographic area where the vessel operates.

6. The control system of claim 5, wherein tiled data includes layers of data the geographic area associated with the tiled data, the layers including one or more layers for representation of geographic location coordinates, water depth data, waterway location data, navigational rules and electronic navigational chart data, navigational objects, radar return data, sonar data, video imaging data, LIDAR data, and data related to objects in adjacently situated tiled data.

7. The control system of claim 1, wherein the tile data represents a geographic region identified by a unique identifier indicating that geographical area, each tile data providing data within a geographic tile identified by specific geographical coordinates.

8. The control system of claim 7, wherein tile data for adjacent geographical regions may overlap.

9. The control system of claim 1, wherein one or more of the plurality of sensor systems can operate to classify objects independently.

10. The control system of claim 1, wherein some of the plurality of sensor systems can include a sensor fusion process to identify objects.

11. The control system of claim 10, further including object tracking.

12. The control system of claim 1, wherein the plurality of sensors includes one or more sensors from a group of sensors consisting of
at least one LIDAR sensor located in the front and rear areas of the vessel;
at least one radar sensor located on the vessel;
at least one camera located in the front and rear areas of the vessel; and
at least one inertial measurement system.

13. An edge node, comprising:
a memory;
a communications unit, the communications unit configured to communicate with a at least one other edge node, a cloud unit, and one or more autonomous vessels; and
a processing unit coupled to the memory and the communications unit, the processing unit executing instructions stored in the memory to
receive sensor data from the one or more autonomous vessels,
determine a geographic position of a target vessel of the one or more autonomous vessels,
associate a tile data with the geographic position, the tile data stored in the memory and providing data associated with feature objects within a tiled region associated with the tile data, and
provide data results to the target vessel that is associated with performance of a mission of the target vessel.

14. The edge node of claim 13, wherein the instructions to provide data results to the target vessel includes instructions to provide the tile data.

15. The edge node of claim 13, wherein instructions to provide data results to the target vessel includes instructions to
determine location of substantial objects from the tile data,
compare the location of substantial objects with objects determined from the sensor data,
plan an operation to be performed by the target comparison and a mission of the target vessel;
determine a sequence of operating parameters to execute the operation, and
associate the data results with the sequence of operating parameters to the target vessel.

16. The edge node of claim 13, wherein instruction to provide data results includes instructions to
determine a share of computation;
execute the share of computation to determine the data results.

17. The edge node of claim 13, wherein the processing unit further executes instructions to
receive a request for computational resources from the target vessel; and
communicate with other edge nodes to fulfill the request.

18. The edge node of claim 13, wherein the tiled data is associated with the tile within a geographical area associated with the geographic position, a collection of tiled data associated with tiles that are arranged to span the geographic area where the vessel operates, and wherein tiled data associated with a service area of the edge node being stored in the memory.

19. The edge node of claim 13, wherein the processing unit further includes instructions to
adjust tile data in response to the sensor data;
upload adjusted tile data to the cloud unit; and
receive tile data adjusted by other edge nodes from the cloud unit.

20. The edge node of claim 18,
wherein tiled data includes layers of data the geographic area associated with the tiled data, the layers including one or more layers for representation of geographic location coordinates, water depth data, waterway location data, navigational rules and navigational data, navigational objects, radar return data, sonar data, video imaging data, LIDAR data, and data related to objects in adjacently situated tiled data.

21. The edge node of claim 13, wherein the tile data represents a geographic region identified by a unique identifier indicating that geographical area, each tile data providing data within a geographic tile identified by specific geographical coordinates.

22. A method of controlling a vessel, comprising:
receiving sensor data from a plurality of sensor systems that are distributed on the vessel, the plurality of sensors collecting sensor data related to objects adjacent the vessel, at least one of the plurality of sensor systems determining a geographic location of the vessel;
providing sensor data to one or more edge nodes in communication with the vessel, the one or more edge nodes associated with the geographic location of the vessel;
receiving tiled data from the one or more edge nodes;
determining operating parameters to perform a mission task based on tiled data from the one or more edge nodes and the sensor data, the tiled data associated with the geographical position of the vessel, the tiled data including data associated with feature objects within the geographic area associated with the tiled data;
determining control signals from the operating parameters; and
providing control signals to a vessel control array, the vessel control array configured to control vessel heading and speed according to the control signals.

23. The method of claim 22, determining the operating parameters includes
receiving the tiled data associated with the geographic location of the vessel from the one or more edge nodes;
determining location of substantial objects from the tiled data;
comparing the substantial objects with objects detected from the plurality of sensors;
planning an operation based on the comparison and the mission task of the vessel; and
determining a sequence of operating parameters to execute the planned operation.

24. The method of claim 22, wherein determining operating patterns includes
determining a subset of the one or more edge nodes to calculate a sequence of operating parameters to execute a planned operation consistent with the mission task; and
receiving, from the subset, a sequence of operating parameters.

25. The method of claim 22, wherein determining operating parameters includes
determining a subset of the one or more edge nodes;
receiving a partial computation of the operating parameters from the subset of the one or more edge nodes; and
determining operating parameters from the partial computation.

26. The method of claim 22, wherein the tiled data is associated with a tile within a geographical area where the vessel operates, the collection of tiles arranged to span the geographic area where the vessel operates.

27. The method of claim 26,
wherein tiled data includes layers of data the geographic area associated with the tiled data, the layers including one or more layers for representation of geographic location coordinates, water depth data, waterway location data, navigational rules and navigational data, navigational objects, radar return data, sonar data, video imaging data, LIDAR data, and data related to objects in adjacently situated tiled data.

28. The method of claim 22, wherein the tile data represents a geographic region identified by a unique identifier indicating that geographical area, each tile data providing data within a geographic tile identified by specific geographical coordinates.

29. The method of claim 22, wherein one or more of the plurality of sensor systems can operate to classify objects independently.

30. The method of claim 22, wherein some of the plurality of sensor systems can include a sensor fusion process to identify objects.

31. The method of claim 30, further including object tracking.

32. A method of operating an edge node, comprising:
receiving sensor data from one or more autonomous vessels;
determining a geographic position of a target vessel of the one or more autonomous vessels;
associating a tile data with the geographic position, the tile data providing data associated with feature objects within a tiled region associated with the tile data, and
providing data results to the target vessel that is associated with performance of a mission of the target vessel.

33. The method of claim 32, wherein providing data results to the target vessel includes providing the tile data.

34. The method of claim 32, wherein providing data results to the target vessel includes
determining a location of substantial objects from the tile data,
comparing the location of substantial objects with objects determined from the sensor data,
planning an operation to be performed by the target comparison and a mission of the target vessel;
determining a sequence of operating parameters to execute the operation, and
associating the data results with the sequence of operating parameters to the target vessel.

35. The method of claim 32, wherein providing data results includes
determining a share of computation;
executing the share of computation to determine the data results.

36. The method of claim 32, further including
receiving a request for computational resources from the target vessel; and
communicating with other edge nodes to fulfill the request.

37. The method of claim 32, wherein the tiled data is associated with the tile within a geographical area associated with the geographic position, a collection of tiled data associated with tiles that are arranged to span the geographic area where the vessel operates, and wherein tiled data associated with a service area of the edge node being stored in the memory.

38. The method of claim 32, further including
adjusting tile data in response to the sensor data;
uploading adjusted tile data to the cloud unit; and
receiving tile data adjusted by other edge nodes from the cloud unit.

39. The method of claim 37,
wherein tiled data includes layers of data the geographic area associated with the tiled data, the layers including one or more layers for representation of geographic location coordinates, water depth data, waterway location data, navigational rules and navigational data, navigational objects, radar return data, sonar data, video imaging data, LIDAR data, and data related to objects in adjacently situated tiled data.

40. The edge node of claim 37, wherein the tile data represents a geographic region identified by a unique identifier indicating that geographical area, each tile data providing data within a geographic tile identified by specific geographical coordinates.
